(19) United States
(12) Patent Application Publication
(10) Pub. No.: US 2025/0271219 A1
(43) Pub. Date: Aug. 28, 2025

(54) HEAT EXCHANGER WITH INTERNAL LATTICE NETWORK

(71) Applicant: Addman Intermediate Holdings, LLC, Fort Myers, FL (US)

(72) Inventor: Daniel Saberton, Fort Myers, FL (US)

(21) Appl. No.: 19/063,558

(22) Filed: Feb. 26, 2025

Related U.S. Application Data
(60) Provisional application No. 63/557,923, filed on Feb. 26, 2024.

(51) Int. Cl. F28F 1/42; B33Y 80/00

(52) U.S. Cl. CPC F28F 1/422; B33Y 80/00; F28F 2001/428

(57) ABSTRACT

A heat exchanger 10 which generally includes a heat transfer passage 12 coupled to a plurality of heat transfer fins 14. The heat transfer passage 12 is a generally tubular member having an outer wall 20 having an internal passage 22 configured to receive a first heat transfer fluid (e.g., liquid coolant). As illustrated, the heat transfer passage 12 is generally serpentine, but it will be appreciated the heat transfer passage 12 may have any suitable configuration. The plurality of heat transfer fins 14 are arranged such that spaces 24 are defined between adjacent fins 14 to receive a second heat transfer fluid (e.g., ambient air). In operation, thermal energy from a first heat transfer fluid is passed through the heat transfer passage 12 to the heat transfer fins 14 whereby a second heat transfer fluid receives and dissipates the thermal energy, or vice versa.

### CROSS-REFERENCE TO RELATED APPLICATION

This Application is a Completion Patent Application of co-pending U.S. Provisional Application Ser. No. 63/557,923 filed on Feb. 26, 2024, the disclosure of which is hereby incorporated by reference, including the drawings.

### PRIOR ART

Most heat exchangers rely heavily on coils of tubes packed into a series of metal fins to conduct heat between two separate systems that are closed off to each other. A first fluid such as a gas or liquid is directed through the tubes, which are thermally coupled to the metal fins. A second fluid such as ambient air is passed over the metal fins to remove thermal energy from the first fluid. While conventional heat exchangers work well for their intended purpose, there remains a desire for improvement in the relevant art.

### BACKGROUND OF THE INVENTION

The present application relates generally to heat exchangers and, more particularly, to an additive manufactured heat exchanger with internal lattice heat transfer passages.

### SUMMARY OF THE INVENTION

According to the present invention, a 3D printed or additive manufactured heat exchanger and method of manufacturing is provided herein. The heat exchanger hereof includes: (a) a hollow heat transfer exchanger having an outer wall defining an internal passage configured to receive a first heat transfer fluid; and (b) an internal heat transfer component thermally coupled to the heat transfer passage for thermal exchange with the first heat transfer fluid.

The heat transfer passage includes an internal lattice structure integrally formed with the tubular outer wall within the internal passage, the internal lattice structure is configured to increase a surface area the first heat transfer fluid encounters while flowing through the heat transfer passage to thereby increase a heat transfer rate between the first heat transfer fluid and the heat transfer component.

The outer wall, which is preferably tubular, and the internal lattice structure are formed using an additive manufacturing process.

The heat transfer component generally comprises a plurality of fins or other heat transfer elements thermodynamically coupled to the heat transfer passage and configured to receive a flow of a second heat transfer fluid for thermal exchange with the first heat transfer fluid.

The present invention may be deployed for use with gases and liquids or flowable material.

The internal lattice may be formed using Directed Energy Disposition (DED), Selected Laser Melting (SLM) or the like additive manufacturing processes.

For a more complete understanding of the present invention, reference is made to the following detailed description and accompanying drawing, wherein like reference numerals refer to like features throughout the several views of the drawings.

### BRIEF DESCRIPTION OF THE DRAWINGS

FIG. 1 is a cross-sectional side view of a first embodiment heat exchanger assembly in accordance with the present invention;

FIG. 2 is a cross-sectional top view of a heat exchanger assembly shown in FIG. 1;

FIG. 3 is a cross-sectional view of a second embodiment of a heat exchanger assembly; and

FIG. 4 is a cross-sectional view of a further embodiment of the heat exchanger assembly of the present invention.

### DETAILED DESCRIPTION OF THE INVENTION

As noted above, the present application is directed to assemblies and methods for manufacturing a 3D printed or additive manufactured heat exchanger. The heat exchanger hereof is formed by providing raw powder material or wire, which is subsequently melted to shape the metal alloy heat exchanger. The heat exchanger may be fabricated using directed energy deposition (DED) and/or selective laser melting (SLM) manufacturing processes, which use high-powered energy sources (e.g., lasers) to melt the powder or the wire base material to deposit material on a substrate and form the component in the well-known manner.

The heat exchanger hereof comprises internal heat transfer channels or passages of a highly conductive material as well as a unique mechanical structure to promote and improve thermal exchange (heating or cooling) of a fluid flowing therein. In this way, heat transfer passages (e.g., tubes) may be significantly reduced in length, thereby reducing the amount of material required for manufacture, as well as the physical dimensions and weight are reduced.

Alternatively, the heat transfer passages may be formed in large solid pieces of metal such as dies and internal combustion engines for their cooling. However, it will be appreciated that the systems and methods described herein may be utilized in any application involving heat transfer between liquids, gases, or molten material through an additive manufactured metallic interface.

The heat transfer passage may be printed with fins and/or lattice structures to increase the amount of surface area the fluids encounter as they pass through the passages. Such structure is configured to increase the heat transfer rate and reduce the size of the heat exchanger by reducing the length of tubing embedding the fins, thereby providing the same or similar amount of heat transfer as traditional tube-only designs. These internal structural features (fins/lattice) may be achieved utilizing the DED and/or SLM manufacturing processes or the like.

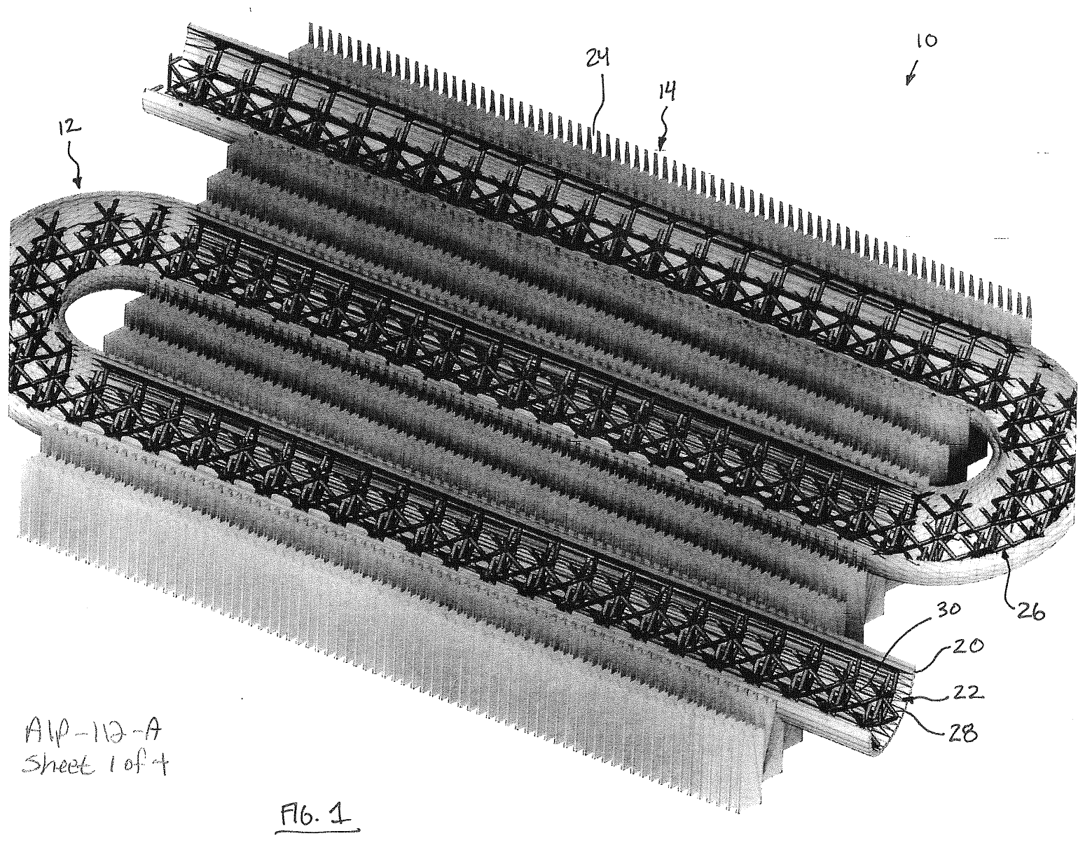

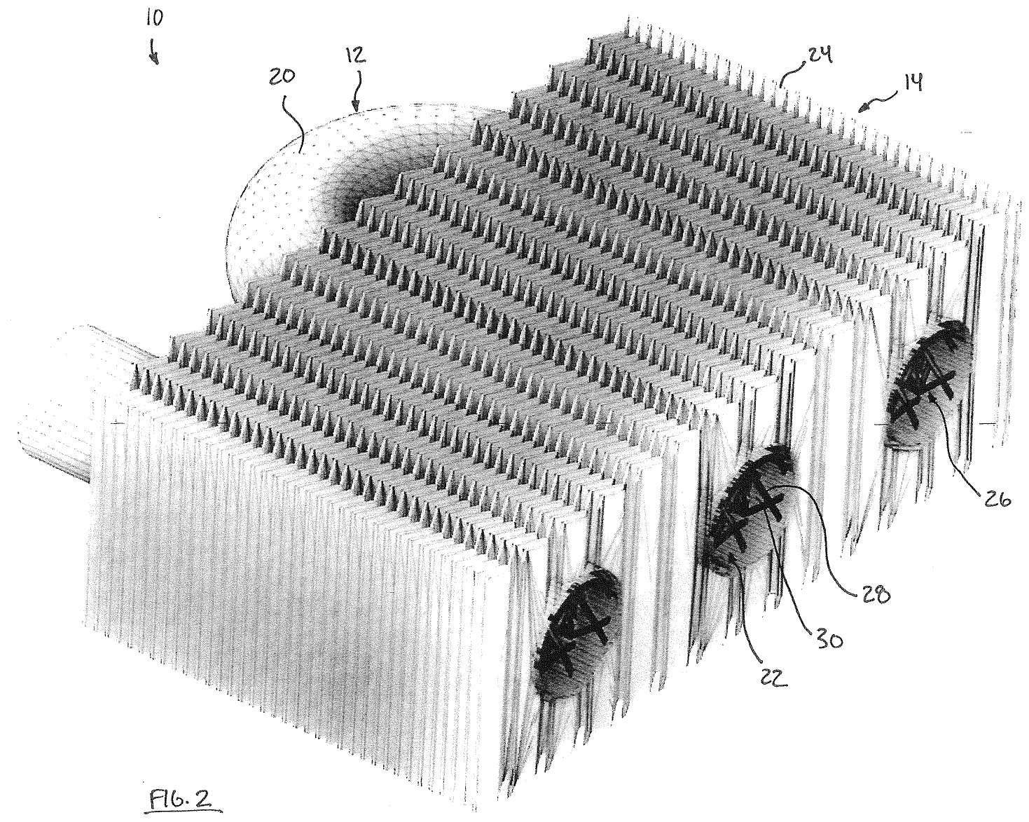

With more particularity and referring now to the drawings and, in particular, FIGS. 1 and 2, a heat exchanger assembly 10 is formed in accordance with the principles of the present disclosure. The heat exchanger assembly 10 is fabricated from an additive manufacturing process where software programs (e.g., computer aided design) are utilized (usually a slicer) to cause deposition of one or more base materials layer upon layer to form a precise three-dimensional object. Such manufacturing is in contrast to traditional subtractive manufacturing processes where material is removed from an intermediate product, for example via machining, to form a final product.

The present additive manufactured heat exchanger assembly 10 is preferably fabricated using directed energy deposition (DED) and/or selective laser melting (SLM) additive manufacturing techniques. However, other additive manufacturing techniques such as binder jetting, material jetting, material extrusion, sheet lamination, direct metal laser sintering (DMLS), selective laser sintering (SLS), laser metal deposition (LMD), electron beam, or the like may be used herein.

The heat exchanger assembly 10 generally includes a heat transfer passage 12 coupled to a plurality of heat transfer fins 14. The heat transfer passage 12 is a generally tubular member having an outer wall 20 having an internal passage 22 configured to receive a first heat transfer fluid (e.g., liquid coolant). As illustrated, the heat transfer passage 12 is generally serpentine, but it will be appreciated the heat transfer passage 12 may have any suitable configuration. The plurality of heat transfer fins 14 are arranged such that spaces 24 are defined between adjacent fins 14 to receive a second heat transfer fluid (e.g., ambient air). In operation, thermal energy from a first heat transfer fluid is passed through the heat transfer passage 12 to the heat transfer fins 14 whereby a second heat transfer fluid receives and dissipates the thermal energy, or vice versa.

The heat transfer passage 12 is additionally formed with an additive manufactured internal lattice structure 26 which is coupled to the outer wall 20 to improve heat transfer with the first heat transfer fluid. The internal lattice structure 26 is configured to increase the amount of surface area the first heat transfer fluid encounters as it passes through the internal passage 22. As a result, the heat transfer passage 12 provides an increased heat transfer rate, which enables the heat transfer passage 12 and thus the heat exchanger assembly 10 to be reduced in size and length compared to conventional designs.

As shown, the lattice structure includes a repeating pattern of unit cells, repeating geometric units, and/or a pattern of interconnected geometric units. The lattice structure may be the same or different unit cells of different density or shape. The lattice structure 26 includes a plurality of interconnected, overlapping, intersecting, and/or woven ribs or struts 28 defining a plurality of apertures 30. The ribs 28 may have the same or different thicknesses and/or widths and may be oriented at the same or different angles. The apertures 30 may have various shapes such as diamond, elliptical, or rectangular shapes. The apertures 30 may be consistent or different throughout the lattice structure 26, and the open area defined by the apertures 30 is greater than the solid or closed area defined by the ribs 28. As such, the patterns formed by the lattice structure 26 may be uniform or non-uniform. As described herein in more detail, the lattice structure 26 may be a unitary structure formed via additive manufacturing.

Although not shown, a computer modeling and additive manufacturing system may be utilized to manufacture the heat exchanger assembly 10. The computer modeling and additive manufacturing system may include a CAD system for designing and generating a computer model of one or more portions of the heat exchanger assembly 10, the CAD system including a processor, a memory, and a user input (e.g., input device and display). The processor is configured to generate the computer model of the heat exchanger assembly 10 according to inputs and data received from a user or other computing device. One or more computer programs are stored in the memory and are executable by the processor to perform the additive manufacturing process to fabricate the heat exchanger assembly 10.

The computer modeling and additive manufacturing system may also include an additive manufacturing device (not shown) having a base material (e.g., metal) in a powder, pellet, wire, or other suitable form. The device feeds the base material to a material applicator, which may include a melting device (e.g., laser, heater, or the like) to melt the base material onto a previously constructed layer.

In a particularly preferred illustration of manufacturing the present heat exchanger using suitable software, such as computer aided manufacturing (CAM) software, a serpentine or other desired configuration of the outer tube 20 is modeled. Thereafter, a volumetric tube conforming to the shape of the outer tube is modeled using the same or similar software. The volume is then transferred into the interior of the outer tube wherefrom a software, such as a slicer, creates the lattice from the volumetric tube and the data is stored. Thereafter, the exchanger is additively manufactured from a suitable machine per instructions from its software.

As is known to the skilled artisan, a slicer is software that acts as an intermediary to link the modeling software to the manufacturing software. The slicer software is configured to transform a digital model into instructions for the 3D printing device and may be used throughout one or more steps of the manufacturing process described herein.

Referring again to the drawing, the embodiment of FIGS. 1 and 2 illustrates the heat transfer passage 12, including the outer wall 20 and internal lattice structure 26 being fabricated as a unitary, monolithic component from a highly heat conductive material (e.g., copper or other metal) via an additive manufacturing process such as DED or SLM. In this way, the internal lattice structure 26 is configured to increase heat transfer surface area and thus the heat transfer rate of the heat transfer passage 12. The heat transfer fins 14 may be subsequently mechanically coupled (e.g., welded) to the heat transfer passage 12, or alternatively, the heat transfer fins 14 may also be formed via the same or different additive manufacturing process. The heat transfer fins 14 may be fabricated from the same material as or a different material than the heat transfer passage 12.

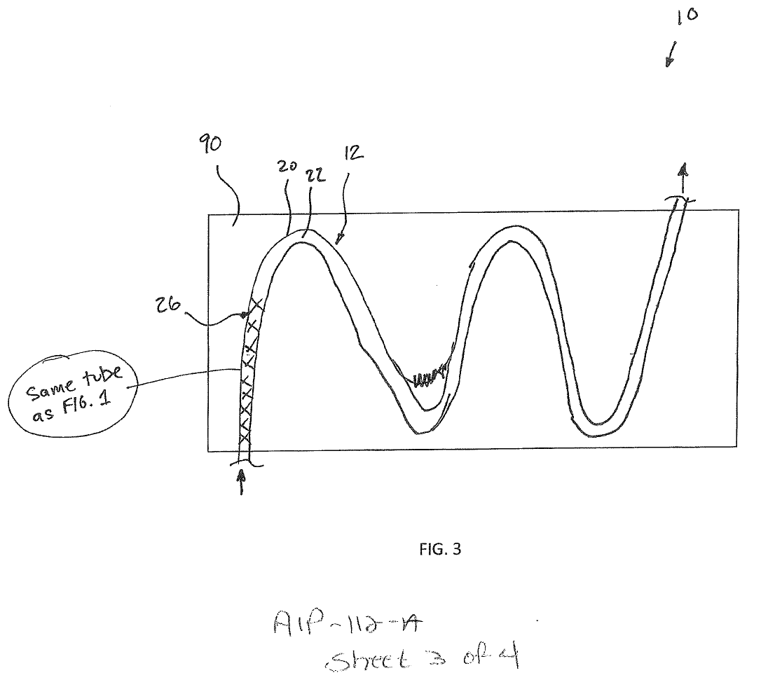

Referring now to FIG. 3, the heat transfer passage 12 may be integrated into a solid component 90 rather than be fitted with heat transfer fins 14. The solid component 90 may be, for example, an internal combustion engine block, die, or mold. According to this embodiment, the heat transfer passage 12 is formed via the additive manufacturing process. Thereafter, the passage is subsequently cast or molded into the solid component 90, which is fabricated from a different material (e.g., aluminum) than the heat transfer passage 12. As noted above, the solid component 90 may also be formed via an additive manufacturing process.

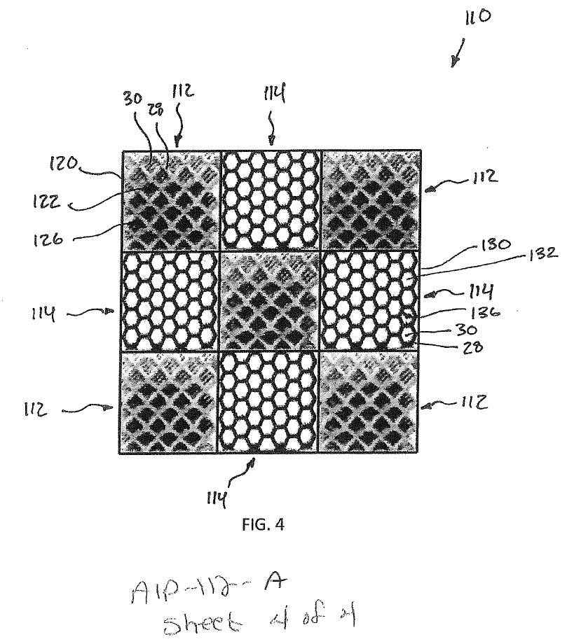

Referring now to FIG. 4, there is shown a further embodiment of the heat exchanger assembly 110 hereof. As shown, the heat exchanger assembly 110 includes a first heat transfer passage 112 and a second heat transfer passage 114 formed via an additive manufacturing process, such as DED and/or SLM. The heat transfer passage 112 is a generally tubular member having an outer wall 120 defining an internal passage 122 configured to receive a first heat transfer fluid (e.g., liquid coolant). The first heat transfer passage 112 is formed with an internal lattice structure 126 similar to that of the first embodiment to improve heat transfer, as previously described for internal lattice structure 26. Although not shown, the various sections of the first heat transfer passage 112 shown in FIG. 4 are fluidly connected, for example, at the ends of the heat exchanger assembly 110.

Similarly, the second heat transfer passage 114 is a generally tubular member having an outer wall 130 defining an internal passage 132 configured to receive a second heat transfer fluid (e.g., oil). The second heat transfer passage 114 is formed with an internal lattice structure 136 similar to lattice structure 26, to further improve heat transfer. Although not shown, the various sections of the second heat transfer passage 114 shown in FIG. 4 are fluidly connected, for example, at the ends of the heat exchanger assembly 110. In the illustrated embodiment, the first and second heat transfer passages 112, 114 have a square cross-sectional shape to minimize the amount of material between the two closed fluid systems and to maximize the surface area for heat exchange therebetween.

It will be appreciated that the first and second heat transfer passages 112, 114 may have any suitable cross-sectional shape that enables the heat exchanger assembly to function as described herein. Moreover, it will be appreciated that the first heat transfer passage 112 may be fabricated from the same or a different highly heat conductive material as the second heat transfer passage 114. Manufacturing the first and second heat transfer passages 112, 114 via the additive manufacturing process(es) enables the passages to be formed with the complex internal lattice structures 126, 136 to provide improved heat transfer therebetween and reduced material usage and waste.

As noted above, the heat transfer passage may be formed from a highly conductive material, such as copper, which may result in a smaller heat exchanger than would otherwise may be necessary. Where used for the passages or channels, the heat exchanger, due to requiring less passage length, the conductor or conductive material may be homogenous throughout the entire component. For components such as engine blocks or conformal cooling dies, the heat transfer passage is printed out of the highly heat conductive material, which is different than the base material of the component. The printed heat transfer passage may then be cast within the component or the component itself is printed around the heat transfer passage. Such a multi-material process may be achieved utilizing the DED manufacturing process.

Such manufacturing processes also enable heat exchange designs other than the tube-in-fin or tube-in-block designs. For example, in a heat exchanger with two closed systems of liquid or gas where both systems are flowing through their own separate tubes in the heat exchanger, the tubing may have a generally square shape to enable a minimum amount of material between the two systems with maximized surface area for heat exchange. Smaller structural features that are not achievable through DED, or parts that are subject to extreme environments, may still leverage the invention describe herein by creating this mechanical design inside the heat transfer passages using the base material of the part with SLM printing technology.

It is to be appreciated that there has been described herein systems and methods for an additive manufactured heat exchanger assembly with reduced size and improved heat transfer. The heat exchanger assembly includes a heat transfer passage formed with an internal lattice structure via an additive manufacturing process such as DED and/or SLM, or the like. The internal lattice structure provides increased surface area for a fluid passing through the heat transfer passage, thereby increasing heat transfer to thermally coupled components such as fins, solid components (e.g., engine block, die), or other additively manufactured heat transfer passages.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A heat exchanger comprising:
(a) a tubular member having an outer wall and a first internal passage and at least one opening for delivering a first fluid into the passage;
(b) an internal lattice structure disposed in the passage, the lattice including a plurality of interconnected, overlapping or woven struts which cooperate to define a plurality of apertures; and
(c) a plurality of fins thermodynamically coupled to the internal passage exteriorly of the internal passage.

2. The heat exchanger of claim 1 wherein:
the heat exchanger is manufactured including the tubular member, lattice and fins manufactured by additive manufacturing.

3. The heat exchanger of claim 2 wherein:
the heat exchanger has a serpentine configuration.

4. The heat exchanger of claim 3 wherein:
the tubular member is a closed loop heat exchanger.

5. The heat exchanger of claim 2 wherein:
the heat exchanger is manufactured by a DED or SLM process.

6. The heat exchanger of claim 1 wherein:
the fins are defined by a solid component of a material differing from that of the tubular clement and lattice.
